(19) United States
(12) Patent Application Publication
(10) Pub. No.: US 2024/0224194 A1
(43) Pub. Date: Jul. 4, 2024

(54) MONITORING LOCATION OF A TRANSCEIVER IN A NETWORK TO MITIGATE INTERFERENCE

(71) Applicant: Charter Communications Operating, LLC, St. Louis, MO (US)

(72) Inventor: David Grant, Austin, TX (US)

(21) Appl. No.: 18/092,378

(22) Filed: Jan. 2, 2023

(51) Int. Cl. H04W 52/28; H04W 52/32

(52) U.S. Cl. CPC H04W 52/283; H04W 52/32

(57) ABSTRACT

Retrieve a service address from a database of an internet service provider. Obtain a corresponding geographic location from a geographic information system server based on the service address. Associate a transceiver device with the geographic location. The transceiver device is configurable to operate in a standard power mode and a low power mode having a lower power than the standard power mode. Make the geographic location available, over a network, to a database containing locations of active incumbent devices. Obtaining, from the database, approval for the transceiver device to operate in the standard power mode, based on the geographic location and the locations of the active incumbent devices. Operate the transceiver device in the standard power mode, responsive to obtaining the approval.

### FIELD OF THE INVENTION

The present invention relates generally to the electrical, electronic and computer arts, and, more particularly, to mitigating interference in wireless communications and the like.

### BACKGROUND OF THE INVENTION

Interference is an important consideration in radio frequency (RF) communications. Interference includes, for example, co-channel interference (crosstalk) and adjacent channel interference (ACI). The latter is caused by extraneous power from a signal in an adjacent channel, while the former occurs among signals using the same frequencies. Various techniques are employed to reduce co-channel interference. In the familiar licensed spectrum, in some instances, such as commercial radio and television broadcasting, broadcasters are assigned a certain frequency/channel, and other broadcasters are not licensed to use that frequency/channel unless they are sufficiently far away such that interference is highly unlikely.

Unlicensed spectrum refers to the radio frequencies that are open to use by anyone, as long as devices follow certain technical rules. For example, the allowable transmit power may be limited. In some instances, allowable transmit power (expressed in either ERP (Effective Radiated Power) or EIRP (Effective Isotropic Radiated Power)) may also depend on location of the Wi-Fi router. Prior to Wi-Fi 802.11a routers, Wi-Fi 802.11b/g/routers were only designed to operate in the “2.4 GHz” license-exempt band between 2.401 GHz and 2.473 GHz. With the advent of Wi-Fi 6E (IEEE 802.11ax), routers are now capable of operating in the much wider 6 GHz band (5.925-7.125 GHz in the US). Previous Wi-Fi routers typically did not need to take account of interference in their operation, except for some channels in the 5 GHz band that were subject to Dynamic Frequency Selection (DFS), which is a Wi-Fi function that enables wireless local area networks (WLANs) to use 5 GHz frequencies that are generally reserved for radars. Wi-Fi 6 (IEEE 802.11ax) was originally only capable of operating in the 2.4 GHz and 5 GHz bands.

On 23 Apr. 2020, when the Federal Communications Commission (FCC) voted on and ratified a “Report and Order” to allocate the entire 1200 MHz of unlicensed spectrum in the 6 GHz band for Wi-Fi use, there were some caveats put in place to mitigate potential interference with previously existing devices that already occupied the 6 GHz band. The FCC currently defines two types of device classifications with very different transmit power rules. The power level choices in the US now are as follows: (i) Low Power Indoor (LPI) Routers or APs (access points) for indoor only Wi-Fi and (ii) Standard Power (SP) Routers or APs for indoor or outdoor Wi-Fi. The LPI Routers and APs, as the name implies, have reduced power levels, since they are only to be used indoors. Any building walls will further attenuate the signals, making any potential interference with existing 6 GHz users very unlikely. Refer to Federal Communications Commission, THE COMMISSION BEGINS THE PROCESS FOR AUTHORIZING 6 GHZ BAND AUTOMATED FREQUENCY COORDINATION SYSTEMS, ET Docket No. 21-352, Public Notice FCC 21-100 Released: Sep. 28, 2021, expressly incorporated herein by reference in its entirety for all purposes.

Wi-Fi 6 includes two power classifications: one for devices that support AFC (automatic frequency coordination) and the other for devices that do not support AFC. The latter must (please note that “must” here refers to a particular regulatory regime and other regulatory regimes or other aspects not implementing particular regulations could take a different approach) operate in an LPI (low power indoor) mode. A higher power mode (standard power mode) is available, but only for devices in compliance with AFC. The AFC process requires 95% confidence on the location of the wireless device (e.g., router or access point) including details on the longitude, latitude, and altitude from the ground (or from sea-level). One pertinent difference between Wi-Fi 6 and Wi-Fi 6E is that the latter can operate in the 6 GHz band.

There is an FCC requirement that operators report the X, Y, and Z coordinates of routers and the like to a database every 24 hours. Assuming no interference is anticipated, the operator is advised what channels, bandwidth, and power levels are available for SP operation for the next 24 hours. Routers typically cannot operate outdoors, their locations are reported (typically, inside a building).

### SUMMARY OF THE INVENTION

Principles of the invention provide techniques for monitoring location of a transceiver in a network to mitigate interference. In one aspect, an exemplary method includes storing geographic location information in a memory portion of a tag device; affixing the tag device on a fixed surface; reading the location information with a reader portion of a front end chip of a transceiver device adjacent the tag device, the transceiver device having a high power mode and a low power mode; making the location information available, over a network, from the reader portion of the front end chip of the transceiver device to a database containing locations of incumbent devices; obtaining, from the database, approval for the transceiver device to operate in the high power mode, based on the location information and the locations of the incumbent devices; and operating the transceiver device in the high power mode, responsive to obtaining the approval.

In one aspect, another exemplary method includes retrieving a service address from a database of an internet service provider; obtaining a corresponding geographic location from a geographic information system server based on the service address; associating a transceiver device with the geographic location, the transceiver device being configurable to operate in a standard power mode and a low power mode having a lower power than the standard power mode; making the geographic location available, over a network, to a database containing locations of active incumbent devices; obtaining, from the database, approval for the transceiver device to operate in the standard power mode, based on the geographic location and the locations of the incumbent devices; and operating the transceiver device in the standard power mode, responsive to obtaining the approval.

In another aspect, an exemplary system includes a memory, and at least one processor, coupled to the memory, and operative to carry out or otherwise facilitate any one, some, or all of the method steps disclosed herein. For example, in one or more embodiments, the at least one processor is operative to retrieve a service address from a database of an internet service provider; obtain a corresponding geographic location from a geographic information system server based on the service address; associate a transceiver device with the geographic location, the transceiver device being configurable to operate in a standard power mode and a low power mode having a lower power than the standard power mode; make the geographic location available, over a network, to a database containing locations of active incumbent devices; obtain, from the database, approval for the transceiver device to operate in the standard power mode, based on the geographic location and the locations of the active incumbent devices; and cause operation of the transceiver device in the standard power mode, responsive to obtaining the approval.

In yet another aspect, a non-transitory computer readable medium includes computer executable instructions which when executed by a computer cause the computer to carry out or otherwise facilitate any one, some, or all of the method steps disclosed herein.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a machine readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus (e.g., a server such as a domain proxy server, optionally associated with additional servers/components of an Internet Service Provider (ISP)) including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
a simple technique for mitigating interference from devices such as wireless routers;
ability for Internet Service Providers (ISPs) with a known cable modem e.g., DOCSIS (or similar device for fiber optics (Service optical network unit (S-ONU), digital subscriber line (DSL), etc.) to use a geographic information system (GIS) in conjunction with data related to the cable modem to determine with the parameters that need to be sent to the AFC operator database every 24 hours;
tamper resistance;
accurate location determination of wireless equipment with automated periodic location reporting not requiring repetitive human intervention; and
improvement in the technological process of installing, operating, and maintaining a communications network, such as a cable/fiber broadband communications network (broadband cable fiber is used herein to refer to a primarily wired network using coaxial cable and/or fiber optic cable, such as shown in FIGS. 1-9), with wireless access provided within customer premises.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10 shows aspects of an exemplary mobile app on a mobile phone, tablet, or other mobile device, useful in connection with aspects of the invention;

FIG. 11 shows the app being used to add a Wi-Fi 6E router to the customer's account;

FIG. 12 shows an exemplary configuration of a mobile device such as a mobile phone, cellular-enabled tablet, or cellular-enabled laptop, which can implement the app depicted in FIGS. 10 and 11;

FIG. 13 depicts an exemplary tamper-proof near-field communication (NFC) tag included within a sticker, in accordance with aspects of the invention;

FIG. 14 shows aspects of an AFC location measurement process, within the app depicted in FIGS. 10 and 11;

FIG. 15 shows a router in accordance with an aspect of the invention, which works with the tag of FIG. 13 and includes a miniaturized digital altimeter/barometric pressure sensor;

FIG. 16 is a system level diagram showing a circular antenna, a near-field communications (NFC) front end chip, and a sticker with tag such as in FIG. 13;

FIG. 17 shows aspects of location determination of devices using a geographic information system (GIS);

FIG. 18 is a block diagram showing interface of wireless access points with an AFC database and GIS database, according to aspects of the invention;

FIG. 19 shows additional aspects of location determination of devices using a geographic information system (GIS); and

FIG. 20 shows exemplary data to be sent to an AFC database in one or more embodiments.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

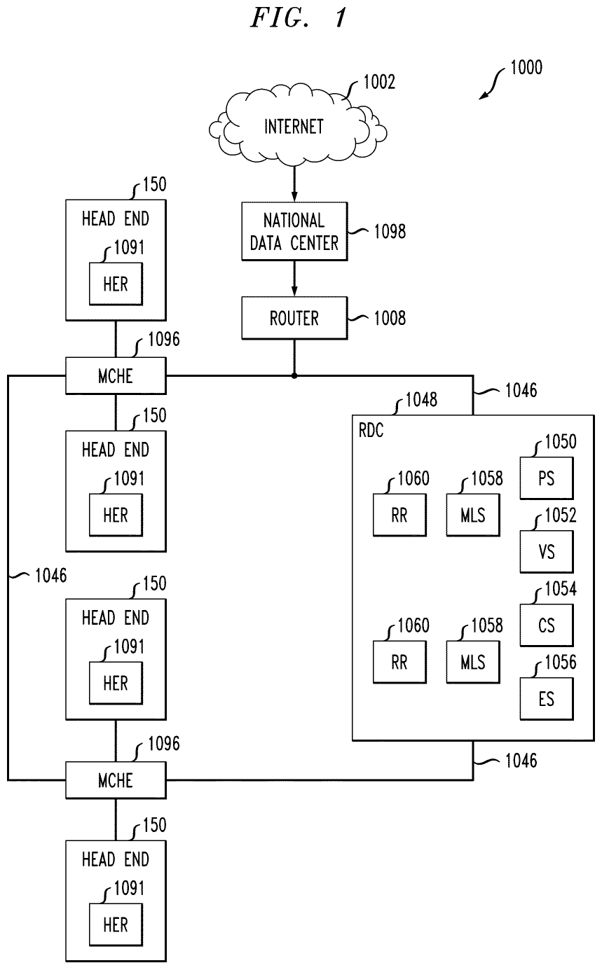

Purely by way of example and not limitation, some embodiments will be shown in the context of a cable multi-service operator (MSO) providing data services as well as entertainment services, and including, for example, a wireless router/wireless access point within customer premises. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP)(transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers (ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

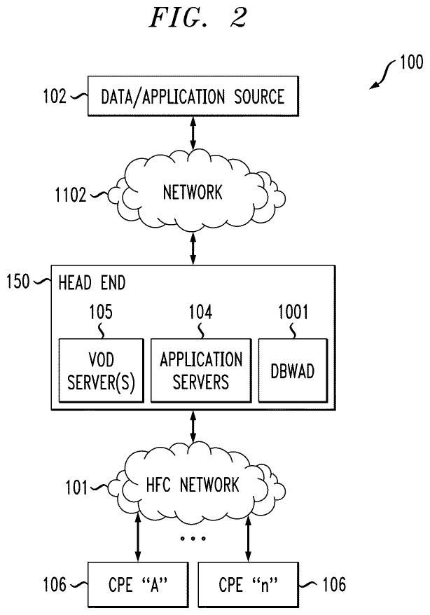

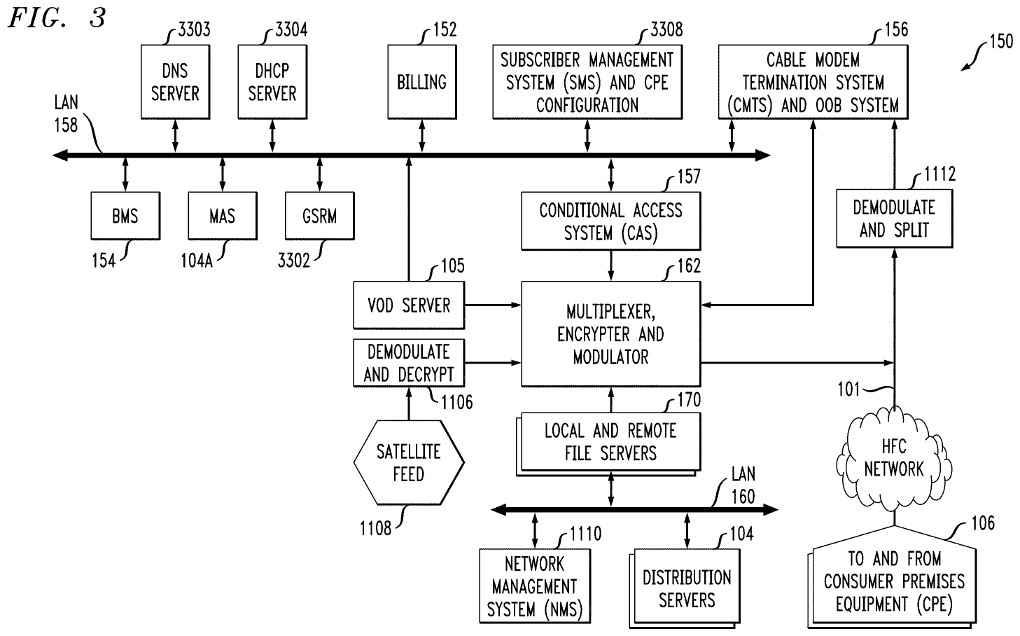

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

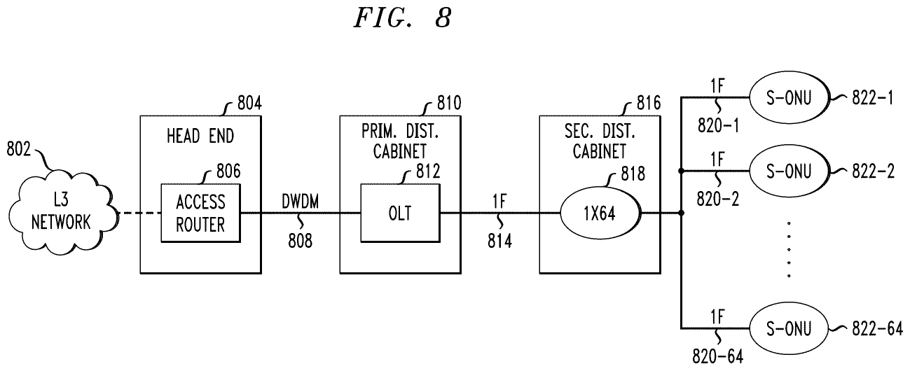

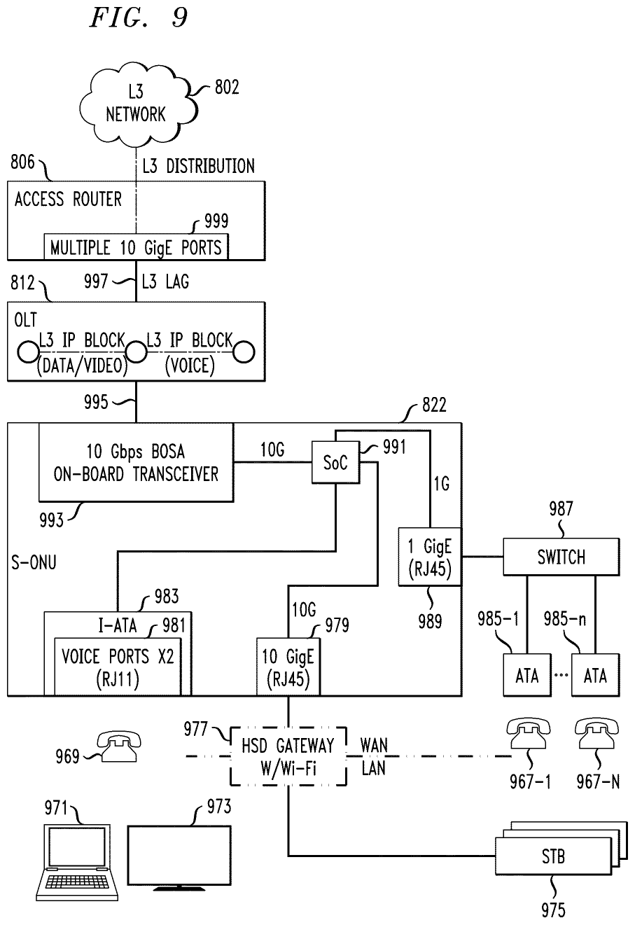

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

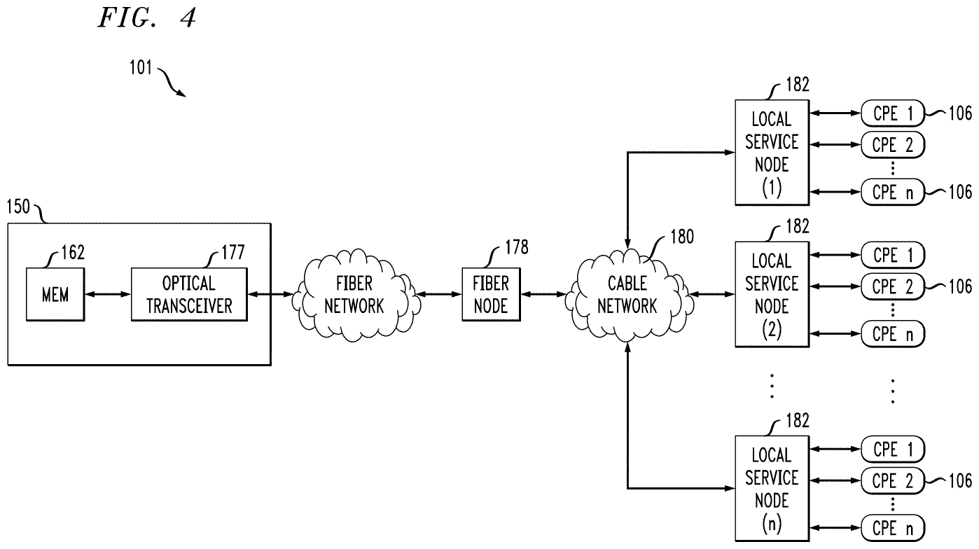

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

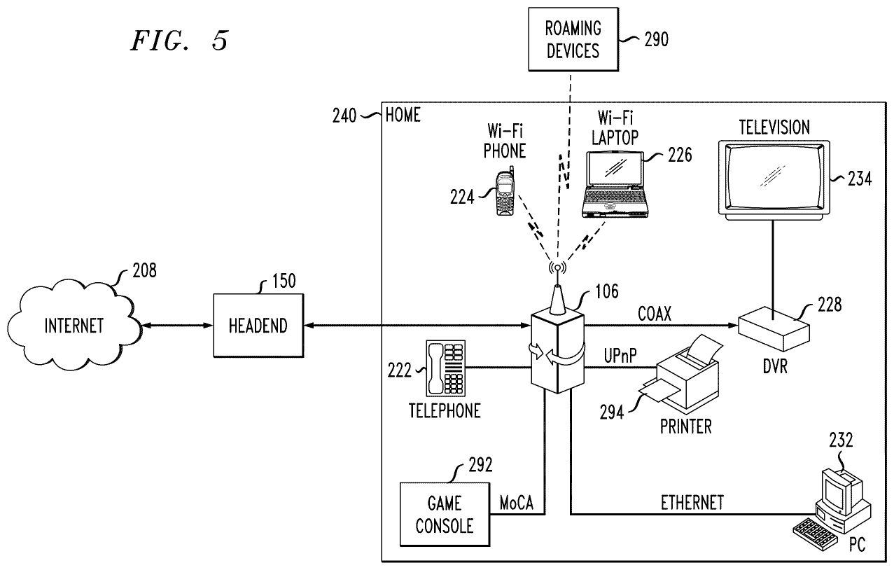

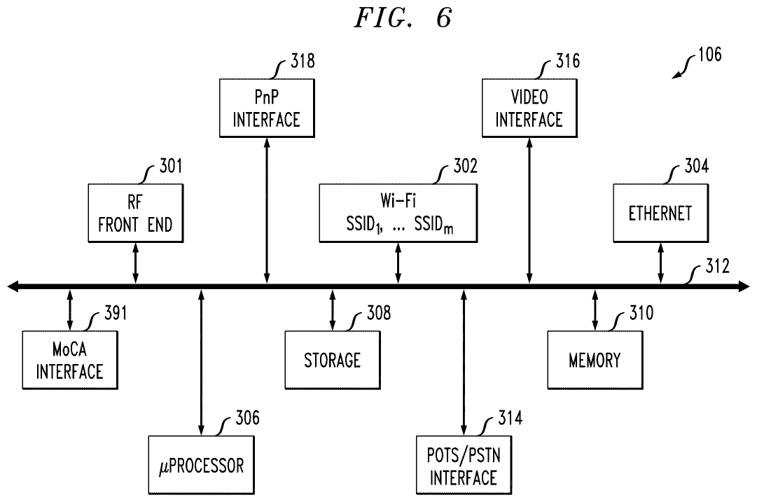

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment—see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VoIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that a cloud-based user interface can be provided if desired, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 1802 generally represents the elements in FIG. 1 upstream of the head ends 150, while head end 1804, including access router 1806, is an alternative form of head end that can be used in lieu of or in addition to head ends 150 in one or more embodiments. Head end 1804 is suitable for FTTH implementations. Access router 1806 of head end 1804 is coupled to optical line terminal 1812 in primary distribution cabinet 1810 via dense wavelength division multiplexing (DWDM) network 1808. Single fiber coupling 1814 is then provided to a 1:64 splitter 1818 in secondary distribution cabinet 1816 which provides a 64:1 expansion to sixty-four S-ONUs 1822-1 through 1822-64 (in multiple premises) via sixty-four single fibers 1820-1 through 1820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 1806 is provided with multiple ten-Gigabit Ethernet ports 1999 and is coupled to OLT 1812 via L3 (layer 3) link aggregation group (LAG) 1997. OLT 1812 can include an L3 IP block for data and video, and another L3 IP block for voice, for example. In a non-limiting example, S-ONU 1822 includes a 10 Gbps bi-directional optical subassembly (BOSA) on-board transceiver 1993 with a 10G connection to system-on-chip (SoC) 1991. SoC 1991 is coupled to a 10 Gigabit Ethernet RJ45 port 1979, to which a high-speed data gateway 1977 with Wi-Fi capability is connected via category 5E cable. Gateway 1977 is coupled to one or more set-top boxes 1975 via category 5e, and effectively serves as a wide area network (WAN) to local area network (LAN) gateway. Wireless and/or wired connections can be provided to devices such as laptops 1971, televisions 1973, and the like, in a known manner. Appropriate telephonic capability can be provided. In a non-limiting example, residential customers are provided with an internal integrated voice gateway (I-ATA or internal analog telephone adapter) 1983 coupled to SoC 1991, with two RJ11 voice ports 1981 to which up to two analog telephones 1969 can be connected. Furthermore, in a non-limiting example, business customers are further provided with a 1 Gigabit Ethernet RJ45 port 1989 coupled to SoC 1991, to which switch 1987 is coupled via Category 5e cable. Switch 1987 provides connectivity for a desired number n (typically more than two) of analog telephones 1967-1 through 1967-n, suitable for the needs of the business, via external analog telephone adapters (ATAs) 1985-1 through 1985-n. The parameter “n” in FIG. 9 is not necessarily the same as the parameter “n” in other figures, but rather generally represents a desired number of units. Connection 1995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve.

Principles of the present disclosure will be described herein, at least in part, in the context of techniques for monitoring location of a transceiver in a network to mitigate interference; indeed, of apparatus, systems, computer program products, and/or methods for monitoring location of a transceiver in a network to mitigate interference. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

A non-limiting example will be presented with respect to recent actions of the US Federal Communications Commission (FCC). However, it is to be understood that one or more embodiments are generally applicable to situations where transceiver power should be limited unless it is known with high probability that there are no other devices nearby that would likely be interfered with by the transceiver. Such situations may arise for technical and/or regulatory reasons. Aspects are also applicable to different regulatory regimes outside the US. In the US, the FCC has voted on and ratified a ‘Report and Order’ to allocate the entire 1200 MHz of unlicensed spectrum in the 6 GHz band (5.925-7.125 GHz) for Wi-Fi use. However, there were some caveats put in place to mitigate potential interference with previously existing non-Wi-Fi incumbent devices that already occupied the 6 GHz band. The promise of this additional bandwidth offered up to seven “brand new” 160 MHz channels, or a whole swath of 80 MHz, 40 MHz and 20 MHz channels for Wi-Fi Routers, access points (APs) and devices to become available. Plans for Wi-Fi 7 already mention optional support for 320 MHz channels.

However, enabling access to all this “new” unlicensed bandwidth required certain tradeoffs with regard to transmit power from the 6 GHz radio in a capable Wi-Fi router, AP or other Wi-Fi device. While the range of the 2.4 GHz band is considerably further than the 5 GHz band, the 6 GHz band's default operating power for Wi-Fi routers, APs and other devices was mandated to be about sixty-three times lower compared to the 5 GHz band. Thus, instead of having a range that would traditionally cover thousands of square feet, the 6 GHz band would only be able to cover a radial sphere of about 8 meters (about 24 feet), which corresponds to about 576 square feet of coverage.

Being limited to such a small coverage footprint is a serious impediment to the world-wide adoption of the precise type of mobile devices that would directly benefit from an extremely high throughput (EHT) Wi-Fi connection in addition to extremely low latency. Non-limiting examples include AR (Augmented Reality) glasses and mobile device applications, MR (Mixed Reality) glasses and mobile device applications, and VR (Virtual Reality) headsets. Indeed, it is believed that such applications are note feasible in current Wi-Fi implementations, but will require Wi-Fi 6E (Wi-Fi 6E is the upcoming standard for an extension of Wi-Fi 6 (also known as 802.11ax), enabling the operation of features in the unlicensed 6 GHz band, in addition to the currently supported 2.4 GHz and 5 GHz bands) and Wi-Fi 7 with exclusive operation in the 6 GHz band.

Within Wi-Fi 6, the FCC currently defines two types of device classifications with very different transmit power rules. The choices as of today are: (i) Low Power Indoor (LPI) Routers or APs or Fixed Location Devices for indoor Wi-Fi deployment; and (ii) Standard Power (SP) Routers or APs or Fixed Location Devices for indoor Wi-Fi or outdoor Wi-Fi deployment. The latter requires precise knowledge of the device's location. Given that the physical shipping address or address of record in an MSO's system may or may not necessarily be the same as the billing address or location of the AP or Wi-Fi router, neither of these available data points can be relied on as a guarantee to the FCC as to the precise X, Y, Z location of the AP or Wi-Fi router. Additionally, using just a customer premise address does not meet the AFC requirement in terms of 95% confidence. Furthermore in this regard, the AFC process (mandated by the FCC) requires 95% confidence on the location of the AP or Wi-Fi router, including provision of details on the longitude, latitude, and altitude from the ground (or from sea-level). The AFC process requires reporting the precise location of the router to an FCC database every 24 hours; otherwise the AP or Wi-Fi router is required to fall back to LPI mode.

Incumbent 6 GHz devices could show as being currently operational in one or more of the potential operational channels in the 6 GHz Wi-Fi band from day to day, so there is no guarantee to any AP or Wi-Fi router (or to the corresponding Wi-Fi devices that connect to them) that SP mode in ANY 6 GHz channel may be allowed during the time period of incumbent 6 GHz device occupation. The router can easily be moved (advertently or inadvertently) by the customer from one location to another within the premises (or even outside the premises) between power-on/off states or even while the router is still on. One or more embodiments advantageously prove a mechanism to ensure that the router will revert to LPI mode if it is moved.

### “Tag” Embodiment(s)

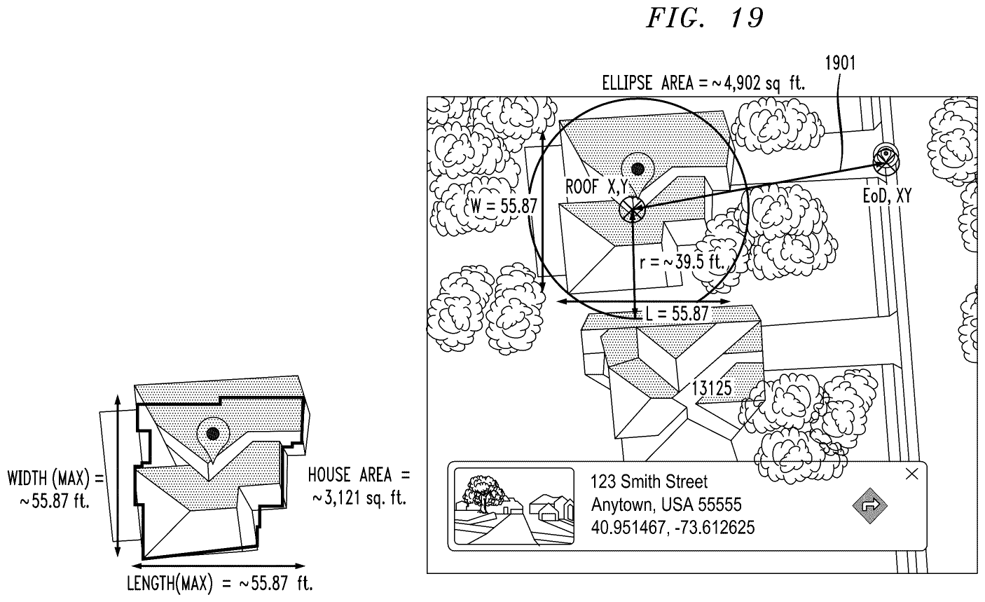

One or more embodiments advantageously detect when a router or other device is not in a previously captured location (such location being captured when AFC Location Measurement coordinates have been captured and entered into the system/AP/router/mobile app/AFC database, and the like). (Aspects of the AFC database are described below with respect to FIG. 18 in the context of a GIS embodiment with a GIS server; however, the “tag” embodiment can make similar use of the other components described therein). One or more embodiments employ two integrated circuits (ICs) and a tamper-proof near-field communication (NFC) tag or sticker to achieve automatic daily reporting of the precision X and Y location of the AP or Wi-Fi router (NTAG® brand tags available from NXP B.V. EINDHOVEN NETHERLANDS are a non-limiting example; there are many different types of such tags that implement data security and tamperproof functionality, as will be familiar to the skilled artisan). One or more embodiments employ an altimeter or barometric pressure sensor IC to automatically measure the altitude or elevation of the AP or router, post calibration of the device upon initial activation and/or power-up. One or more embodiments employ an integrated NFC (Near Field Communications) reader IC to read the contents of a tamper-proof NTAG sticker that is placed either within radio proximity of (6-10 inches, say, depending on power), and in a non-limiting example, underneath the AP or the Wi-Fi router (e.g., on a fixed surface such as a wall, floor, ceiling, fixed mantelpiece or counter of a structure and a piece of furniture that is not wheeled and weighs at least 75 pounds; on an immovable surface). In one or more embodiments, this NTAG sticker is programmed by either a mobile technician or a customer with the measured X, Y and Z coordinates. Movement of the AP or router beyond a predetermined distance (e.g., 10 cm) will automatically be detected by the integrated NFC reader and the unit will revert to LPI mode. Attempts to move (or remove) the NTAG sticker will result in the NTAG sticker X, Y, Z location information being damaged; the unit will then revert to LPI mode.

Thus, by way of review and provision of additional detail, Wi-Fi 6 is the latest standard of 802.11 Wi-Fi technology. The FCC has opened up the unlicensed 6 GHz band for use with Wi-Fi devices. Two power classifications are included. One is for devices that support AFC (automatic frequency coordination) and the other is for devices that do not support AFC. For the latter (including all devices currently on the market), Wi-Fi 6E access points/routers, and Wi-Fi 6E enabled phones, operation is in LPI (low power indoor) mode, which is about sixty three times lower power than the current 5 GHz Wi-Fi band. The lower power rating corresponds to a limited range for both access point/router and the device(s) that connect to the access point/router. In the relevant standards, including AFC System to AFC Device Interface Specification Version 1.3 © 2022 Wi-Fi Alliance and AFC System Reference Model Version 1.0 © 2021 Wi-Fi Alliance, only if the access point or router indicates to the device(s) that it is connected to that the access point or router is allowed to be in standard power mode are the device(s) that are connected to it also allowed to be in standard power mode. If the access point or router indicates to the device(s) that are connected to it that the access point or router is only allowed to be in LPI, then all the devices that connect to it all have to be in LPI as well. AFC System to AFC Device Interface Specification Version 1.3 © 2022 Wi-Fi Alliance and AFC System Reference Model Version 1.0 © 2021 Wi-Fi Alliance are both expressly incorporated by reference herein in their entireties for all purposes.

LPI power level limitations correspond to about 8 m/24 feet of spherical radius around the access point or Wi-Fi router. When the FCC approved the 1200 MHz of available spectrum in the 6 GHz band, it enabled about thirty-seven times more bandwidth (BW) than has previously been available to Wi-Fi devices, considering both 2.4 GHz available bandwidth and 5 GHz available BW. This is a significant increase. However, because the FCC required that all Wi-Fi devices must be subordinate to any 6 GHz non-Wi-Fi incumbent devices (e.g., TV satellite dishes, microwave dishes, digital microphones, and the like) the Wi-Fi 6E routers must be indoor only and must run in LPI mode only (please note that “must” here refers to a particular regulatory regime and other regulatory regimes or other embodiments not implementing particular regulations could take a different approach). Note that the router must be indoors in LPI mode, but can be indoors or outdoors in standard power mode. However, only select channels and a certain bandwidth and power will be available in SP mode, regardless of whether the router is indoors or outdoors. Also, again, “must” in this context refers to embodiments that comply with the relevant standards; other embodiments for situations that do not require adherence to the standards do not necessarily mandate indoor operation. If it was desired to run them in standard power mode, it was required that they come into compliance with AFC. Once permission to operate in AFC mode has been given, the devices can have about the same power level as a 5 GHz device (say, upgrading range from about 24 feet to about 72 feet of range). The ability to operate in standard power mode has a beneficial impact on entire Wi-Fi ecosystem. Indeed, the desire for more Wi-Fi BW is driven by the fact that more and more devices are moving to Wi-Fi. Wi-Fi is unlicensed and there is no fee for using it, other than the connectivity costs associated with the Internet Service Provider (ISP). This is in contrast to other technologies, such as 4G LTE and 5G cellular networks, which have an associated services licensing agreement and per-bit cost associated with them. Typically, even in non-Wi-Fi networks where usage is uncapped, at some point the provider slows down the customer's data.

Some cable MSOs or other ISPs may have arrangements with wireless telephony providers (e.g., MSO/ISP functions as a Mobile Virtual Network Operator (MVNO)). Significant savings (e.g., for the MSO, which can be passed along to the consumer) may be available by offloading cellular traffic onto home Wi-Fi, as well as a significant boosting in mobile device speed. Further, Wi-Fi 6E and 7 will allow adoption of VR (virtual reality)/AR (augmented reality)/SR (simulated reality)/VW (virtual world) technologies which require high data throughput with wireless connectivity and low latency. The potential 1200 MHz of available BW for Wi-Fi 6E and 7 may not be achievable in practice unless there is a usable coverage area in the home/office/factory/multi-dwelling unit (MDU) or other customer premises. The twenty-four foot sphere corresponds to about 100 ft², but an insufficient area of usage will prevent achieving the benefits of Wi-Fi 6E and 7.

Various parameters are typically employed in an end-to-end AFC solution; these typically need to be reported to an AFC database (typically cloud-based). The cloud-based AFC database is typically fed from an FCC-controlled database that lists all the 6 GHz incumbent devices. The AFC database also typically has data contributed from the router itself, or some device connected to the router (wired or wireless), which will report the XYZ domain (longitude, latitude, altitude above ground or above sea level) with 95% confidence as to that reporting location (e.g., sphere, circle, ellipse). The typical router includes a radio transceiver. The location is reported to the AFC database with a certain area of certainty/uncertainty as well as XYZ coordinates and measurement method (ellipse, sphere) that was used to measure certainty/uncertainty. Once reported to the AFC database, there is some associated cloud-based processing. The larger the area of uncertainty, the more calculations are needed. The database is aware of the location of the router that has requested permission enter standard power mode, as well as the locations of all the surrounding 6 GHz incumbent devices. These incumbent devices may, for example, be on one day and off another. This aspect leads to the next requirement: the router typically must (please note that “must” here refers to a particular regulatory regime and other regulatory regimes or other embodiments not implementing particular regulations could take a different approach) report its XYZ coordinates to the AFC database every 24 hours. One or more embodiments advantageously meet this requirement with minimal consumer action. It would be undesirable to require a professional installer/technician, or the consumer, to measure and report every 24 hours. One or more embodiments advantageously provide an automated mechanism.

One or more embodiments employ an NFC read/writer embedded inside the router plus an external NTAG approach. In one or more embodiments, after measurement is made (for example, by a technician or consumer using a suitable application (“app”) (provided, for example, by an MSO or a third party; the skilled artisan is familiar with such applications), the information is recorded, and sent into the router by a mobile app or some other mechanism. Furthermore regarding the “app,” the skilled artisan will be familiar with various suitable applications such as the MSO My Spectrum app available from Charter Communications, Stamford, CT, USA; the MSO Xfinity app available from Comcast Corporation, Philadelphia, PA, USA; and third party apps available from third party router manufacturers such as Netgear, Inc., San Jose, California, USA or Linksys Holdings, Inc., Irvine, CA, USA) In one or more embodiments, inside the bottom of the router, there is an NFC reader/writer IC chip. On a surface underneath the NFC chip is a sticker that shows the consumer/installer/measurer where to place the router—say, an oval space with a ¼ inch to ½ inch area around it. Advantageously, the “place in this area” notation can be readily seen and the consumer will know that if the router gets bumped/disturbed, it should be moved back into that area. Inside the sticker, on the surface underneath the router, is an “NTAG” (a secure near-field communications device). When it is within range of the NFC reader in the router (e.g., about 10 cm), the tag will be able to read the stored information.

In one or more embodiments, the first time after the measurement is done, information including XYZ, measurement method, whether Z is above sea level or above ground, MAC address of device, and serial number of the device is written into the NTAG and a command is also sent to make the NTAG read only. Henceforth, the information in that sticker cannot be changed. Now, measurements every 24 hours are not needed. As long as the router is on top of the sticker, within range, the NTAG can be read into the NFC reader every 24 hours and the chip in the router can automatically report to the AFC database in the cloud. The reported information includes the unique location of the device corresponding to the MAC address of the 6 GHz band radio—this is known to be unique because there are no duplicate MACs. The AFC database responds to the chip in the router that there are no incumbents nearby and the router is free to operate at standard power in the 20, 40, 80, and 160 MHz bandwidth channels. This information is relayed to the consumer's mobile app or an embedded web page of the router so that people can see that the router has entered standard power mode. This is a benefit to both the MSO and the consumer: the consumer has a good Wi-Fi experience—high throughput, low latency, and high coverage. The use of an MSO-supplied router that can operate in standard power mode when appropriate is potentially better for the consumer than a commercially available retail router which is not exempt from FCC AFC mandate.

It is to be emphasized that while examples have been given in the context of the US FCC, aspects of the invention are applicable wherever it is desired to know the precise location of a transceiver to mitigate interference, including, but not limited to, jurisdictions outside the US that have organizations like the FCC and their own rules about what spectrum they plan to open up in the 6 GHz band, and whether there will be different permissible powers depending presence of incumbent devices, periodic geographic location reporting requirements, and the like.

It will be appreciated that regulatory authorities have required Wi-Fi unlicensed devices to be subordinate to incumbent 6 GHz devices to prevent technological issues related to interference. If a Wi-Fi device went improperly into standard power, and was not appropriately located, issues could arise. For example, suppose the unlicensed device was right next to a TV satellite dish which operates in the 6 GHz space. Interference would be forced onto the dish from the consumer's router and this would degrade operation. Thus, one or more embodiments solve a technical problem by permitting use of available spectrum at full power when it is unlikely to cause interference. In one or more embodiments, a cloud-based AFC database arbitrates this process.

In one or more embodiments, a technician encodes the location of the NTAG sticker, places the sticker on a desk of similar piece of furniture, and the router sits on top of the NTAG. One or more embodiments are implemented in a tamper-proof manner, so that a failure will result if the sticker is tampered with or moved, and that the router will revert to low power mode. It is not desirable that people should be able to circumvent the AFC system. In one or more embodiments, information is encoded into the router, including how the measurement was made to obtain XYZ—this could include, for example, a mobile app (consumer, third party, or tech) as discussed elsewhere herein, or the like. The AFC database typically requires a certain accuracy for the device location; for example, 95%. In some instances, to obtain this level of confidence, the size of the envelope needs to be increased. In one or more embodiments, the XY location (longitude and latitude) is recovered via line of sight (LOS) with GPS or a similar Global navigation satellite system (GNSS). For this reason, it is not appropriate to simply place a GPS unit in the router, because it may not be near a window and likely will not have line of sight to multiple GNSS satellites. In one or more embodiments, a technician or consumer employs a suitable mechanism that has a GNSS receiver in it, such as a mobile device, and then creates a wireless connection (e.g., Bluetooth, Wi-Fi) back to the router. One or more embodiments automatically or manually determine the offset from the measured GPS location where the mobile (measurement) device was to where the physical location of the router is. That information, once calculated and finalized, is written into the NTAG by the integrated NFC read/write chip in the bottom of the router. In one or more embodiments, the NTAG is designed to be tamper-proof, such that, if the NTAG is peeled up, it will be damaged and the NFC chip will no longer be able to read it. In one or more embodiments, the consumer and MSO are advised of the tampering and the router goes back into low power indoor mode. In one or more embodiments, the router itself encodes the NTAG and locks the NTAG into read-only mode.

Given that routers may need periodic maintenance or replacement, one or more embodiments allow placing a new router right on the existing tag.

One or more embodiments employ an NFC read/write chip at the bottom of the router; for example, operating at 13 MHz and low power (the skilled artisan is familiar with typical power levels for NFC). In one or more embodiments, even though the setup is wireless, the consumer is prevented from picking up and moving the router. One or more embodiments employ NFC communications as are used in a contactless payment card, including encrypted data and close proximity. In one or more embodiments, if the router is moved, the router is degraded to low power mode, and the service degradation is noted. One or more embodiments are believed to provide a better solution than GPS or an accelerometer in the router. In one or more embodiments, full power service can be recovered (assuming all other appropriate criteria are met, including no incumbent 6 GHz devices too close to the router) once the router is returned to the correct location. In the event of an unusual event such as an earthquake, a technician can be called or a suitable mobile app tells the consumer to center the router on the sticker. In one or more embodiments, a suitable mechanism is provided to detect if the sticker is tampered with (the skilled artisan is familiar with various types of tamper-proof tags that become non-functional if tampered with). In one or more embodiments, routers can operate in standard power mode outdoors. In one or more embodiments, multiple stickers can be provided for various locations, even outdoors by a pool or the like. In one or more embodiments, use can be made of Wi-Fi pods (extenders), which can be implemented, for example, as mesh nodes that are plugged into a standard AC electric outlet in premises to help with poor coverage. An NFC sticker read/write approach can be used to place the sticker right near the electric outlet.

In one or more embodiments, a 6 GHz on-site survey is performed by a technician using highly precise latitude, longitude and altitude location measurement equipment to capture the precise location of the Wi-Fi 6E router. This captured information is then embedded inside a special secure NTAG sticker that is adhered to the surface where the router is to be located. This surface is located on an object that is not readily moveable as discussed elsewhere herein. When the base of the router is located directly on top of this NFC sticker, the information is read by the embedded NTAG reader in the router and sent securely over the internet to a participating secure AFC database. The user does not need to do anything other than assure that the router remains within the boundary of the secure NTAG sticker. Should the router be moved beyond 10 cm from the sticker, the 6 GHz radio in the Wi-Fi 6E router will automatically fallback to LPI (Low Power Indoor) mode which is up to sixty-three times less power output (8 m/24 ft. range) as compared to SP (Standard Power) mode (23 m/75 ft. range).

In accordance with requirements such as regulatory requirements from the FCC or otherwise, the precise location (latitude, longitude, altitude) of any Wi-Fi 6E Router and/or Wi-Fi 6E Pod that desires to operate the 6 GHz radio in a higher power operational mode called SP (Standard Power) must (please note that “must” here refers to a particular regulatory regime and other regulatory regimes or other embodiments not implementing particular regulations could take a different approach) conform to the AFC (Automated Frequency Coordination) process established by the FCC. The precise location of the Router/Pod must (please note that “must” here refers to a particular regulatory regime and other regulatory regimes or other embodiments not implementing particular regulations could take a different approach) be transmitted to the AFC database every 24 hours to confirm that its operation is not impeding that of any/all non-Wi-Fi incumbent 6 GHz devices (e.g. TV satellite transponders, digital microphones, etc.). Without strict compliance to the AFC process as defined by the FCC, all Wi-Fi 6 GHz radios are limited to LPI (Low Power Indoor) mode and hence have an operational range of about 8 m or 24 ft.

In one or more embodiments, an MSO's internet customer qualifies for a Wi-Fi 6E router, and is afforded the option to request a 6 GHz on-site survey by selecting the “6 GHz Site Survey” via a suitable app, web site, or customer service telephone number. It will typically be appropriate to remind the customer that having a 6 GHz on-site survey performed does not necessarily the customer's router will be able to operate in full power mode at any time in the present or future, due to the potential presence of 6 GHz non-Wi-Fi incumbent devices.

Various procedures can be employed to implement one or more embodiments. For example, the consumer can receive a Self-Install Kit (SIK) from a store or obtain one by mail or courier, or installation can be carried out by a technician. The SIK can include directions to scan a code, such as a QR code, on the router using a mobile device. In one or more embodiments, this QR code is dynamic rather than static. In one or more embodiments, instead of just taking the customer to an app store, scanning the code takes the customer to a Wi-Fi 6E landing page that includes a link to either version of the mobile app as well as information about AFC requirements, including what AFC is, why the consumer should be concerned about AFC, and the fact that Wi-Fi 6E devices will not work at full power on the 6 GHz band unless the consumer goes through the AFC setup process.

By way of review, the physical shipping address or address of record may or may not necessarily be the same as the billing address; and the AFC process requires 95% confidence on the location of the router providing details on the longitude, latitude, and altitude from the ground (or from sea-level). Reporting the location of the router to the FCC database is required to be performed every 24 hours. Given that the router can easily be moved from one location to another between power-on states, or even while the router is still on, a suitable mechanism is provided in one or more embodiments to ensure that the router will fall back to LPI mode if it moved after taking the AFC Location Measurement.

In one or more embodiments, a mobile technician arrives at the consumer's physical address with a Wi-Fi 6E router and performs the installation and activation of the device. In one or more embodiments, the technician uses her or his own mobile device running a suitable technician mobile app (such as Service Tech Mobile available from Charter Communications, Stamford, CT, USA) which offers location check functionality. If the user has paid for, or is otherwise entitled to, a 6 GHz on-site survey, the Mobile Tech can measure the X, Y, Z of the router and embed this in a “tamper-proof” tag that is placed under the router.

It is worth noting that in one or more embodiments, if the Wi-Fi 6E router loses power and the consumer refuses to download the MSA app in order to go through the AFC—Location Check himself or herself to re-establish Standard Power mode on the 6 GHz band of her or his Wi-Fi 6E router, the consumer can always call for a mobile technician (and if required by the MSO, pay a suitable amount for the technician to perform the 6 GHz on-site survey). In some instances, the customer may request support via a phone call, web chat, or MSA app chat, in which case customer support will know if the router had moved and/or the tamper-proof tag had been tampered with.

By way of review, due to the fact that the AFC “location reporting process” must (please note that “must” here refers to a particular regulatory regime and other regulatory regimes or other embodiments not implementing particular regulations could take a different approach) be repeated every 24 hours, even if the router was never moved or ever lost power or was ever disconnected from the internet, having the measured location values of the AP or router embedded inside a “tamper-proof” NTAG advantageously addresses this FCC requirement on both the MSO and its customer.

Referring now to FIG. 10, in one or more embodiments a mobile technician opens a suitable app on a mobile phone, tablet, or other mobile device, signs in, and travels to the premises where the 6 GHz on-site survey is to be performed. The technician may also be requested to install a Wi-Fi 6E router during the same visit. Note the mobile device with log-in screen 2001, entry of the active directory username at 2003, entry of the active directory password at 2005, and tapping of the sign-in button at 2007. A map display 2009 can be provided to show the day's calls.

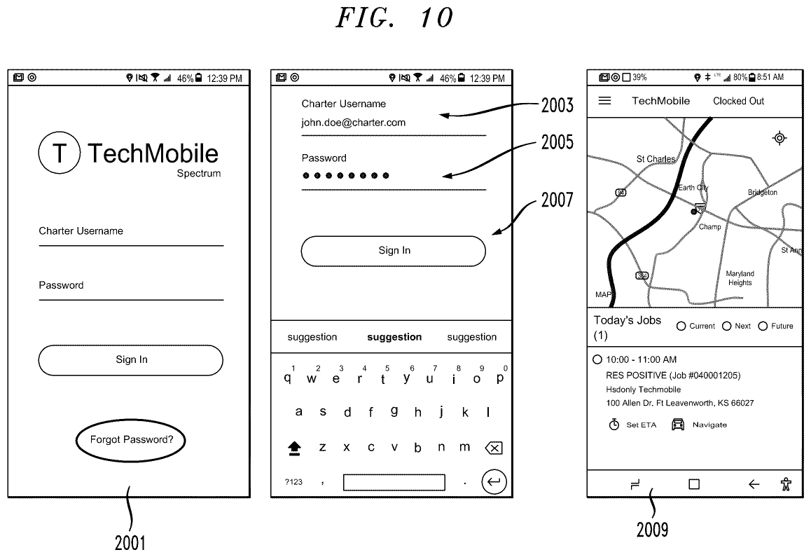

In FIG. 11, the app is used to add the Wi-Fi 6E router to the customer's account. A menu of devices 2011 is provided; when the appropriate one has been highlighted, the “add to account” button 2013 is pressed.

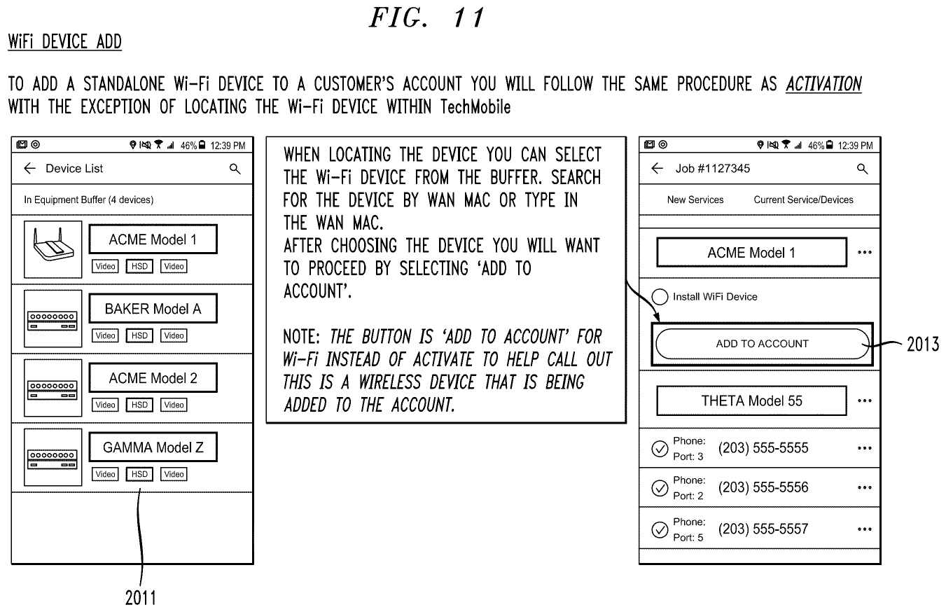

The mobile technician can employ suitable tools including a commercially available laser distance meter with level sensors and capability to function in Pythagorean mode and measure distance, area, and volume; a commercially available portable compact GPS with altimeter, barometer, thermometer, hygrometer, compass, and flashlight; and a “smart” phone 2015 of FIG. 12, tablet, or other portable device with suitable operating system, app, and GPS, 4G, LTE, 5G, Bluetooth Low Energy (BLE), Wi-Fi and/or NFC capability.

FIG. 12 shows an exemplary configuration of a mobile device 2015 such as a mobile phone, cellular-enabled tablet, or cellular-enabled laptop. Device 2015 includes a suitable processor; e.g., a microprocessor 1151. A cellular transceiver module 1161 coupled to processor 1151 includes an antenna and appropriate circuitry to send and receive cellular telephone signals, e.g., 3G, 4G, or 5G. A Wi-Fi transceiver module 1163 coupled to processor 1151 includes an antenna and appropriate circuitry to allow phone 2015 to connect to the Internet via a wireless network access point or hotspot. In one or more embodiments, one or more applications in memory 1153, when loaded into RAM or other memory accessible to the processor cause the processor 1151 to implement aspects of the functionality described herein. Touch screen 1165 coupled to processor 1151 is also generally indicative of a variety of I/O devices, all of which may or may not be present in one or more embodiments. Memory 1153 is coupled to processor 1151. Audio module 1167 coupled to processor 1151 includes, for example, an audio coder/decoder (codec), speaker, headphone jack, microphone, and so on. Power management system 1169 can include a battery charger, an interface to a battery, and so on.

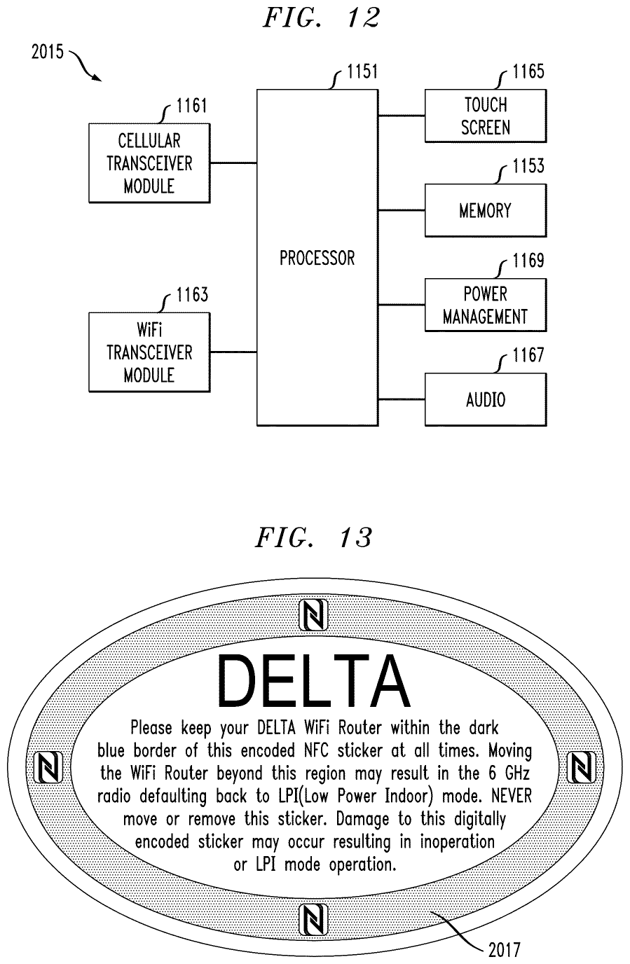

The technician will also have a supply of NTAG stickers 2017 of FIG. 13.

In one or more embodiments, the technician or even the consumer can make use of a commercially available laser distance meter/rangefinder (e.g., with a level sensor or the like). As will be known to the skilled artisan, such devices can measure distance, area, and volume; can determine the height of objects and related measurements using various aspects of the Pythagorean Theorem; and can carry out continuous measurement form a reference point.

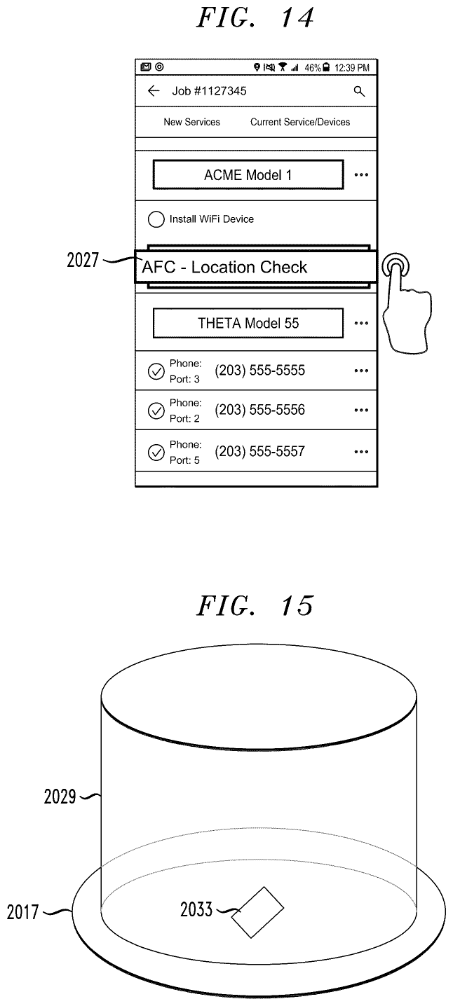

In one or more embodiments, referring to FIG. 14, after the mobile technician is ready to begin the AFC location measurement process, he or she presses the “AFC—Location Check” button 2027 within the app. In some instances, for example, this opens up a new window in the app with multiple blank fields to be filled in, including the same parameters that will ultimately be written into the NTAG sticker by the technician's smart phone or other device. The mobile technician may, for example, start outside with a line of sight to GNSS satellites; using, for example, a handheld GPS/Altimeter device, the longitude and latitude values are captured (for example, out to 6 decimal places). In one or more instances, an altimeter on the same device (or another device) is then “zeroed out” at ground level. In some instances, a laser measurement device or the like is used to capture the distance from the current location to the ground edge of the premises, and is then used to capture the distance from edge of the premises to the router location. Multiple angles may require the use of the Pythagorean function in order to complete accurate X, Y offset values of the router location from the GPS. In one or more embodiments, the altimeter value is captured with the device held right next to the mid-point height of the Wi-Fi 6E router if, for example, the height is not obtained from another technique such as Wi-Fi AoA and time of flight (ToF).

In one or more embodiments, once the AFC location measurement process has completed, it is time to embed the unique location information into the NTAG (or similar) sticker. For example, the mobile technician uses an “Embed AFC Location Information” button in the app and the appropriate information is sent from the app to the tag via NFC or the like. For example, a commercially available tamperproof (tag and data inside are destroyed if tampered with) NFC Forum Type 4 tag (such as the NTAG model 424) could be used, employing the ISO 7816 file system with, for example, a 256 byte NFC Data Exchange Format (NDEF) file, a 32 byte capability container file, and a 128 byte proprietary file, and an ISO 14443-2-3-4 compliant RF interface supporting communication speeds from 106 up to 848 kbps. Appropriate security techniques can be implemented, including encryption/cryptographic authentication—store data in encrypted form and move it securely. More memory will typically be needed when location is stored as a polygon as compared to an ellipse. For the ellipse option, one or more embodiments require storing the major and minor axes, the orientation, and the “ellipse” method. In one or more embodiments, height can be determined from a MEMS sensor as discussed elsewhere herein. Sufficient storage should be present on the tag to store appropriate information (for example, as JavaScript Object Notation (JSON) parameters), including Request ID, Router serial number, location measurement method and corresponding data (e.g., ellipse, major axis, minor axis, orientation, confirmation of indoor deployment, and optionally height, height measurement method, and height uncertainty.

Thus, there can be multiple techniques to determine X and Y (longitude and latitude), such as using the just-described tag method, a global navigation satellite system (GNSS) such as GPS, use of a geographic information system (GIS) plus location database (discussed below), and the like. X-Y can be solved, for example, with a GPS (GNSS) receiver embedded in the router or in a mobile device and via use of Wi-Fi, Bluetooth, or cloud aspects. A GPS signal cannot always be obtained in all locations. In some cases, from RSSI, it is known about how far the mobile device is from the router. An app as discussed above can be used to save the location to the router NTAG.

### Determining Altitude Z

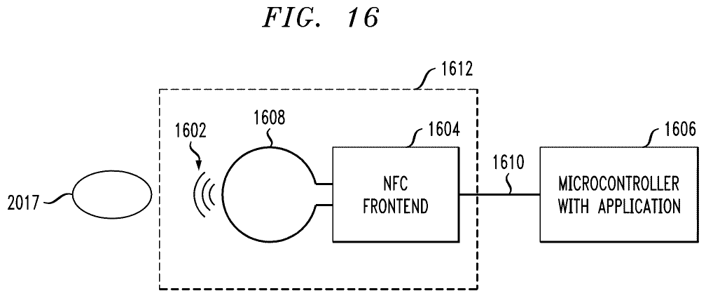

Referring now to FIG. 15, various techniques can be used to accurately measure the altitude or elevation of the AP or router; one or more embodiments (e.g., “tag” and “GIS”) can use an altimeter/barometer. Note the router 2029 and tag 2017. For example, add a commercially available miniaturized digital altimeter/barometric pressure sensor 2033 to the router. The sensor 2033 can be located, for example, on its own piece of plastic on the bottom of the router; e.g., on a printed circuit board (PCB) of the router. Such a sensor can be used, by way of example and not limitation, when it is anticipated that there will be specific instances where an accurate above ground measurement will not be easily obtained—e.g., a high-rise building. In addition to element 2033, the router can also include elements 1612 as discussed elsewhere herein.

Thus, one way to solve for Z is by using a barometer as an altimeter (e.g., embedded inside the router). Z can be measured with respect to local ground (which can be obtained from GIS) or mean sea level. Once in the premises, for example, the user can sign up for a third party service such as NEXTNAV PINNACLE from NextNav, LLC Sunnyvale, CALIFORNIA USA, which makes use of reference barometer beacons throughout the US. Typically, even though the device 2033 is calibrated at the factory, the barometer is a MEMS device subject to both short-term and long-term drift. Over the course of a year, the amount of drift could be as much as 8 meters. A third party service such as NEXTNAV PINNACLE allows obtaining local barometric pressure from a reference beacon of known height—a sensor in the device assumes its height has not changed and recalibrates to the reference beacon. In one or more embodiments, determination of Z does not involve GNSS or GIS. Since the router is connected to the Internet, it can use this third party service to recalibrate the MEMS sensor periodically (say monthly or quarterly). One non-limiting example of a suitable barometric sensor is the BMP 581 barometric pressure sensor available from Bosch Sensortec GmbH Reutlingen, Germany. Other height measurement techniques, such as laser, could be used in other embodiments.

One or more embodiments thus add a commercially available miniaturized digital altimeter/barometric pressure sensor to the router (e.g., a pain printed circuit board (PCB) thereof), such as a Bosch BMP581 or the like. The router fan can be disabled during measurement. This approach can provide, for example, +/−2.5 m absolute accuracy, +/−0.25 m relative accuracy. In one or more embodiments, a service such as the third party NextNav Pinnacle service ensures ongoing accuracy via dynamic recalibration to combat MEMs senor drift, thus achieving, for example, +/−3M accuracy.

One or more embodiments employ the concept of AMSL—average mean sea level—in determining Z. Some commercial services such as NextNav determine the height of the router with respect to adjacent ground level.

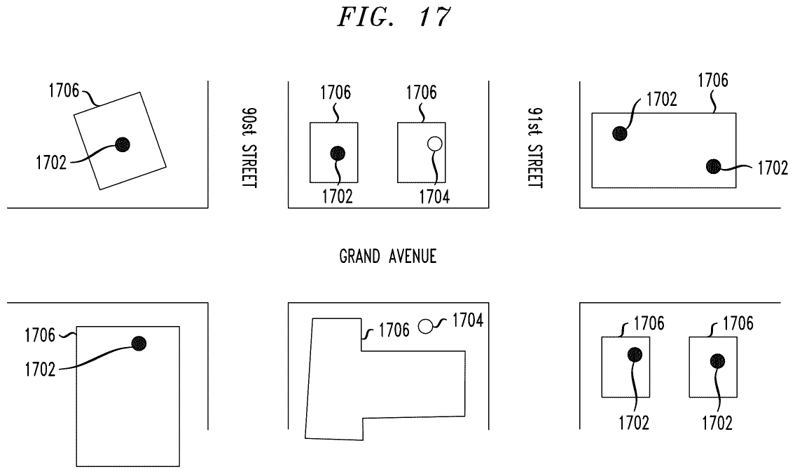

Once the AFC Location measurement values have been embedded inside the tamper-proof secure NTAG sticker or the like, the information is provided to the router and suitable measures are taken to prevent the user from moving the router or removing the NTAG sticker. FIG. 16 is a system level diagram showing a circular antenna 1608, 13.65 MHz wireless signals 1602, an NFC front end chip 1604 (e.g., NXP MFRC630 high-performance front end), and a sticker containing the NFC tag 2017. The elements within the dotted line 1612 can be present in the bottom of the router. The microcontroller with application 1606 can be a Wi-Fi system on chip (SoC) chipset that provides the “brains” or “guts” of the router, as will be familiar to the skilled artisan. Suitable communication techniques symbolized by line 1610 between the NFC front end and the microcontroller include I2C, SPI, RS232, or other suitable serial (or parallel) communication protocol.

One or more embodiments thus ensure the MSO/ISP and the FCC or other regulatory authority that once the router is installed, it will not move, and if it does, it falls back to LPI mode. In one or more embodiments, read/write can be performed, for example, using either the NFC reader IC in the router or via a technician's mobile device. In one or more embodiments, the NTAG can be locked out after X (latitude), Y (longitude), Z (altitude) and other pertinent variables have been written. Advantageously, one or more embodiments do not suffer from signal range limitations, unlike AoA/ToF approaches. Furthermore, after initial set-up, one or more embodiments do not require line of sight (LoS), as would using an integrated GPS/GNSS IC with internal or even an external antenna (e.g. high-rise towers). Advantageously, in one or more embodiments, after the initial 6 GHz on-site survey, no further customer involvement or human intervention is needed. As noted, additional NFC tags can be placed by a mobile technician, in other rooms, near Wi-Fi extender pods, or even outdoors (e.g., near a pool).

### GIS/Database Embodiment(s)

While the above-described “tag” approach can be beneficial in a number of circumstances, it may be somewhat “hands on” and may be vulnerable in case the tag is attached to something that can eventually be moved (e.g., even “heavy” furniture). The application of stickers to surfaces may also be unwelcome in some circumstances. An alternative approach employs a geographic information system (GIS); such a system can make use of, for example, databases with topographic maps generated from LIDAR or the like. One or more such embodiments take advantage of the billing database that an ISP such as an MSO will typically maintain. Such a database will typically include service address data. An ISP typically has a cable modem (or equivalent optical hardware) inside the premises attached to the router, and it is already known where this modem is. While there is some effort required by the ISP/MSO to maintain this database, it is transparent to the end user.

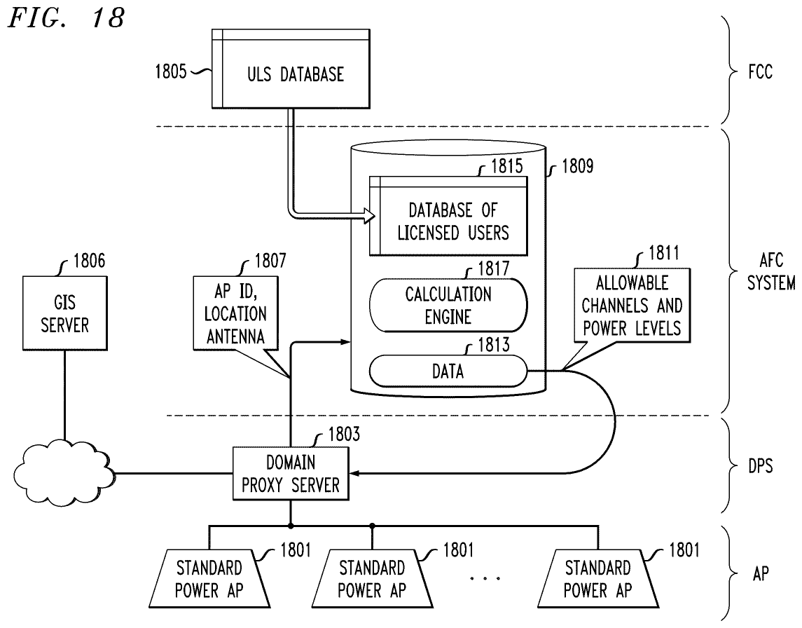

One or more embodiments use the service addresses of the Internet customers found in the billing database in conjunction with the CMTS nodes (generally, fiber S-ONU or HFC cable modem). The cable plant “knows” where all the cable runs are, their distances, and the signals at the mid-way points. Taking the service address, and overlaying with the limitations of where the CMTS zones must be, polygon images can be created. Referring to FIG. 17, when the user zooms in, she or he can see each of the properties including houses.

In another aspect, an ISP such as an MSO may be an MVNO (multiple virtual network operator)—for example, selling mobile telephony services, possibly provided by another entity's network, so that in addition to the modem and the attached router, it is possible to communicate with a mobile device that has access to LTE, 4G, and 5G cell towers, GPS, Bluetooth and Wi-Fi in the router, and the like. The mobile can run a suitable app as described elsewhere herein, and can be spoof-resistant. The phone location will be known and it can be determined, for example, that it is within 50 m of the service address (obtained, e.g., from the billing database/system, which typically stores the owned equipment, customer name, services the customer is paying for, customer phone number, service address, billing address, and the like), and also in 2.4 GHz range so also within 50 m of the outer perimeter of the house.

One or more embodiments make use of a GIS database. Referring to FIG. 17, solid points 1702 include service locations that fall within a building outline 1706 when superimposed, while open points 1704 include service locations that fall outside a building outline when superimposed. It is possible to employ a buffer of, for example, 30 m, 60 m, or 100 m about each point with probabilities of, for example, 94%, 96.6%, and 97.8%. Multiple data sets are available to determine building boundaries using LIDAR and the like. One or more embodiments make use of the accuracy of the service location in the billing database and also of geocoding accuracy (which could be less in rural areas). Accurate location of the unit is desirable to reduce the potential that interference will be found and thus increase the potential that standard power operation will be permitted for more devices on more channels.

In one or more embodiments, determine latitude and longitude of the cable modem (or similar optical unit) from the service location in the billing database. It can be desirable to update the billing database to enhance accuracy, including comparing the type of service to the node. A suitable algorithm superimposes/plots the points (open and solid; could also be color-coded such as, e.g., red and green respectively) (based on latitude and longitude) on the GIS image showing the building shapes, as seen in FIG. 17. Those points that appear within a structure appear solid and the others appear open. The outlines of buildings are often complex, and can be represented by vectors. Alternatively, an ellipse sufficiently large to enclose the structure can be employed.

In another aspect, when the MSO also offers mobile phone service, the location determining aspect using the service address from the billing database can be augmented using the location of the subscriber's mobile phone, in an aspect referred to as hybrid-based location reporting.

Further regarding the specification of the device location, consider that existing 6 GHz rules permit flexible geofence construction (uncertainty regions); for example, ellipse, linear polygon, and radial polygon. The ellipse is specified by the latitude and longitude of the center, the major and minor axes, and the orientation relative to true north. The linear polygon is specified as an array of points, with the latitude and longitude of each point. The radial polygon is specified as an array of vectors, with the latitude and longitude of the center and the angle and distance for each vector specifying the vertices. The uncertainty region can be any shape or size so long as it contains at least 95% of geolocation measurements. Suitable AFC interface transport and security protocols can be employed; for example, use HTTP 1.1 or later, transport layer security (TLS) 1.2 or later, and the AFC message in JSON. Vector data may take longer to download but is more accurate than an ellipse. Three pertinent AFC message types include an available spectrum inquiry request, an available spectrum inquiry response, and optionally, a standalone vendor extension. The available spectrum inquiry request asks the AFC system for the available frequency and/or channel ranges and EIRP levels at the location of the AFC device (e.g., router). The available spectrum inquiry response responds to the AFC device with list(s) of available frequency and/or channel ranges with maximum permissible power and expiration time.

It is worth noting that one or more embodiments are applicable to 6E or to any wireless (e.g., Wi-Fi) access points or routers that are operating in the 6 GHz spectrum, worldwide (more generally, to devices that can operate in two different power modes based on potential interference). It is also worth knowing that while one or more embodiments employ barometers and/or GIS in a new manner, the skilled artisan will be familiar with those technologies in and of themselves, and, given the teachings herein, can adapt know techniques to implement one or more embodiments.

Accordingly, one or more embodiments provide an AFC device location reporting solution leveraging GIS mapping software, GIS data, and a barometer. One or more embodiments are applicable, for example, to routers of an ISP, such as, for example, a cable MSO that also provides high bandwidth data connectivity. One or more embodiments seek to maximize the range of Wi-Fi 6E router in the 6 GHz radio range (i.e., allow operation in standard power mode as opposed to low power mode). As noted, the X, Y, and Z geolocation of a router typically needs to be sent to the AFC System every 24 hours. One or more embodiments employ the customer service address (from the ISP's billing system). One or more embodiments employ GIS software, such as a back-end server software component that makes geographic information available to anyone with an internet connection, using GIS services, which allow a server computer to receive and process requests for information sent by other devices. The skilled artisan will be familiar with suitable software, such as ARCGIS® software (registered mark of Esri (Environmental Systems Research Institute), Redlands, CA, USA). Such software can return, for example, from the service address, the centroid “Roof X, Y” Coordinates (95% confidence), which can be assumed to be centroid of the property structure, and/or end of driveway “EoD X, Y” Coordinates (95% confidence), and so on. Suitable software returns the outline of buildings at the service address and an ellipse or other shape can be imposed to surround the building, or the outline of the building itself can be specified. Alternatively, instead of using commercial software, a “UoM” (Unit of Measure) can be derived from a difference of coordinates between the structure and driveway, and machine learning (ML)/artificial intelligence (AI) can be carried out on a high-resolution satellite image of the property structure, permitting derivation of the maximum length and maximum width of the property structure using the derived UoM; this in turn permits deriving the major axis and minor axis of an ellipse placed around the property (enclosing the most distant corners).

By way of review, part of the compliance with the AFC system requires that the router “reports” its geolocation (with 95% confidence) in X, Y, Z domain coordinates to the AFC system every 24 hours before the router can potentially be authorized by the AFC system to transition from LPI (Low Power Indoor) mode to SP (Standard Power) mode. One or more embodiments employ GIS to solve this challenge.

Referring now to FIG. 18, every 24 hours, every wireless access point 1801 that wishes to operate in standard power mode (e.g., AFC-enabled Wi-Fi 6E router of an ISP such as a cable MSO providing high-bandwidth data services) must report its X, Y, Z geolocation (with 95% confidence) to the AFC database 1809 (for example, using domain proxy server 1803, or directly—the data is stored at 1813). The domain proxy server 1803 then bundles up data from all the routers 1801 and sends a consolidated “data package” 1807 (can include access point ID, X, Y, Z geolocation, antenna data, etc.) on to AFC operator database 1809. Meanwhile, the 6 GHz “non-Wi-Fi incumbents” send their X, Y, Z Geolocation, transmission power, radiation pattern, and channel(s) occupied to the FCC-maintained ULS database 1805; that same data is then made available to the AFC system 1809 (e.g., stored in the database 1815 of licensed users). The calculation engine 1817 determines if potential interference exists. If the AFC system reports “OK” back to the router (e.g., allowable channels and power levels at 1811), the router 1801 can then operate in Standard Power (SP) in the allowable channels and power levels. Otherwise, the AFC System reports “Not OK” back to the router, and the router 1801 remains in Low-Power Indoor (LPI) mode. The GIS server 1806 is shown as connected to the domain proxy server 1803 via s suitable network connection (cloud not separately numbered) but server 1806 can be accessed by other elements of the ISP's network. Note that access points 1801 are designated as “standard power” access points because it is desired to operate them in standard power if possible; however, they may have to operate in low power if they do not receive approval.

Note that the entire element 1809 is referred to for convenience as an AFC database; it can include, for example, a database/data structure 1813 for elements 1801; a database 1815 of licensed/incumbent users, and the calculation engine 1817—these components could be collocated or could be separate, cloud based/networked, etc.

Thus, consider the accurate reporting of the roof X, Y (centroid) coordinates of the structure on the property associated with the customer service address, The ISP supplies the “Internet Customer Service Address” for the Wi-Fi 6E router from its billing system to a GIS server (can be a single server a virtualized server, a cloud-based solution, etc.). The GIS server performs geocoding of the address and returns, for example, two sets of X, Y static geolocation coordinates such as the roof X, Y coordinates (centroid of property structure or centroid of property) and the end of driveway (EoD) X, Y coordinates. The GIS server also has access to high-resolution satellite photo of the property showing both Roof X, Y as well as EoD X, Y coordinates. In some instances, use can be made of a set of deep learning generated building footprints covering a geographical region of interest. The distance between the two sets of X, Y coordinates provides a “unit of measure” (UoM). Using this unit of measure, the maximum width and maximum length of the property structure can be obtained using edge detection and graphical analysis of the overhead satellite photo. In one or more embodiments, the appropriate data is saved in one or more locations, such as flash memory within the routers/Aps 1801, the ISP's customer database (e.g., billing module 152), cloud storage of a cloud management services provider, and the like. The appropriate data can include the static geolocation coordinates such as the roof X, Y coordinates, as well as the calculated major axis, minor axis, and other static parameters for the location of the cable modem, S-ONU, router 1801, embedded multimedia terminal adapter (E-MTA)(cable modem and a VoIP adapter bundled into a single device), etc.

Note that in some instances, a GIS database will already have performed calculations regarding the property and structure outlines. Note also that the “foundational” steps typically do not need to be repeated since changes in the geography and structure are unlikely, but may be repeated periodically over a relatively long period, such as four times per year, to determine if the property structure length/width has changed (e.g., due to building additions or demolition).

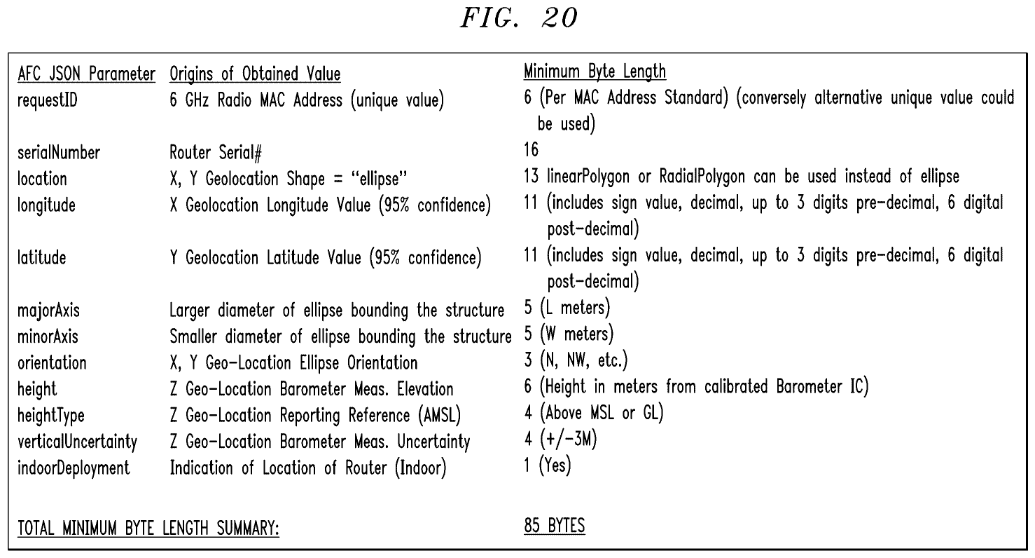

FIG. 19 shows how to determine Length×Width, both axes of the “Ellipse” of the property associated with the service address using the Unit of Measure, it again being understood that commercially available GIS databases, map services, etc. exist with pertinent calculations already having been made. As depicted, the distance 1901 between the two sets of static X, Y coordinates (roof and EoD) provides a “unit of measure” (UoM). Using this unit of measure, the max width and max length of the property structure can be obtained using edge detection and graphical analysis of the overhead satellite photo. Using trigonometry, calculate the radius (r) of the bounding “ellipse” (or circle, as here, if the structure is essentially square). In the example, the radius is about 39.5 feet or about 12.0 meters. For a generally “square-shaped” structure (like in this example), assign 2× radius (r) to both of the AFC JSON parameters (major axis and minor axis) (refer also to discussion of FIG. 20).

FIG. 20 shows exemplary data to be sent to the database 1809 from the Aps 1801 (e.g., via the Domain Proxy Server 1803) every 24 hours, in the form of AFC JSON (JavaScript Object Notation) parameters.

Thus, in one or more embodiments, an ISP supplies an “internet customer service address” (for example, from a billing database) to a GIS Server (in one or more embodiments, this only needs to be performed once). The GIS server performs geocoding to determine the X, Y static geolocation coordinates of the cable modem, S-ONU, router 1801, embedded multimedia terminal adapter (E-MTA) (cable modem and a VoIP adapter bundled into a single device), etc. (in one or more embodiments, this only needs to be performed once).

The X, Y static geolocation coordinates of cable modem, S-ONU, router 1801, E-MTA, etc. are saved in the ISP's customer database, cloud storage of a cloud management services provider, and the like (in one or more embodiments, this only needs to be performed once). The X, Y static geolocation coordinates are copied to flash memory within the routers, cloud storage of a cloud management services provider, etc. (in one or more embodiments, this only needs to be performed once) before data is sent to the AFC Proxy Server every 24 hours.

The Z dynamic geolocation coordinate can be obtained from an integrated barometer MEMs sensor and also sent to the domain proxy server 1803 every 24 hours along with X, Y static geolocation coordinates, Length×Width of Customer Property in AFC JSON Parameter format, etc. The domain proxy server sends all the AFC JSON parameters for every router every 24 hours to the AFC operator database 1809. Every router's AFC JSON parameter data set includes an associated unique identifier (uniqueID), which could use, for example, the router MAC address. The AFC Operator Database replies back to the Proxy Server which replies back to the router; the response includes: OK to operate in SP? Yes or No. If Yes, which channel(s) & power level(s) associated with SP are authorized for the next 24 hours?

### Recapitulation

Given the discussion thus far, it will be appreciated that, in general terms, an exemplary method, according to an aspect of the invention, includes storing geographic location information in a memory portion of a tag device 2017; affixing the tag device on a fixed surface; and reading the location information with a reader portion of a front end chip 1604 of a transceiver device adjacent the tag device. The transceiver device has a high power mode and a low power mode. A further step includes making the location information available, over a network, from the reader portion of the front end chip of the transceiver device to a database containing locations of incumbent devices. See discussion of FIG. 18 below; “tag” embodiments can utilize a similar approach without the GIS server 1806 thereof. Still further steps include obtaining, from the database, approval for the transceiver device to operate in the high power mode, based on the location information and the locations of the incumbent devices; and operating the transceiver device in the high power mode, responsive to obtaining the approval.

As used herein, a “fixed surface” includes a wall, floor, ceiling, fixed mantelpiece or counter of a structure and a piece of furniture that is not wheeled and weighs at least 75 pounds.

The AFC operator database 1809 typically pulls in information from the ULS 1805 database and possibly an ISP's proxy server or a router manufacturer's proxy server or an individual's router (discussed further below). The FCC has dictated that all non-Wi-Fi 6 GHz users; e.g. fixed satellite service, must enter the exact location XYZ, antenna pattern, power level, channels, and bandwidth, every 24 hours. The AFC operator database has incumbent information and information from people requesting to go to standard power in the 6 GHz band.

It is worth noting that in one or more embodiments, the tag device does not use a battery; power is induced via induction, causing the tag to “wake up.” In one or more embodiments, the tag is blank when first installed, and data is added from the “tech” or third party app via cloud/Wi-Fi/Bluetooth to the router, which writes it into the NTAG sticker. A “lockout” command makes the sticker read only. After that, the sticker is read only (e.g., every 24 hours).

In some instances, a consumer can pay a nominal amount to a big box store for installation—the store tech will go to the premises, take measurements, and write them into the sticker. This may be preferable to the end-user doing installation, because there may be doubt as to the consumer attaching the tag to a fixed surface.

With regard to obtaining, from the database, approval for the transceiver device to operate in the high power mode, the AFC database or other similar database will utilize an appropriate algorithm (calculation engine 1817 discussed elsewhere) to determine available frequency and/or channel ranges with maximum permissible power and expiration time, in accordance with known principles.

One or more embodiments further include, after a predetermined time (24 hours is a non-limiting example), repeating reading the location information with the reader portion of the front end chip of the transceiver and making the location information available, over the network, from the reader portion of the front end chip of the transceiver device to the database containing the (updated) locations of the (active) incumbent devices; obtaining, from the database, disapproval for the transceiver device to operate in the high power mode, based on the location information and the (updated) locations of the (active) incumbent devices; and operating the transceiver device in the low power mode, responsive to obtaining the disapproval.

It will be appreciated that incumbent devices per se typically do not move. However, in a 24 hour period they could be online and go offline or vice versa. So, they accordingly need to advise the ULS database 1805 that they will be online for the next X hours in the next 24 hour period; the channel(s) they are going to use; the bandwidth they are going to consume; and the power level they are going to broadcast in, as well as the interference pattern with associated vectors. The AFC operator database 1809 takes this information from the ULS database 1805 and compares it to the requested XYZ location of operation of a Wi-Fi router 1801 which desires to operate there for the next 24 hours in standard power in a certain channel. In one or more embodiments, domain proxy server 1803 gathers all the information from all the routers 1801. In the cloud, AFC operator database 1809 compares the incumbent devices (information in 1815) versus the requests from the Wi-Fi routers 1801 and gives a GO-NO GO decision. If the decision is “GO,” advise what channel, what bandwidth, what EIRP power level are permissible. In one or more embodiments, repeat every 24 hours, for both incumbents and routers 1801. The database entries for ACTIVE incumbent devices could change from day to day. Things that could cause a denial of the request to operate in standard power include: (i) moving the device away from the tag/original location, and (ii) change in the configuration/number of ACTIVE incumbent devices near the desired region of operation.

One or more embodiments further include designating the stored geographic location information in the memory portion of the tag device as read only. The storing can include, for example, storing by a technician using a mobile device with a technician application, or storing by a customer using a customer device with a customer application.

One or more embodiments further include, after a predetermined time, repeating reading the location information with the reader portion of the of the front end chip of the transceiver device and making the location information available, over the network, from the reader portion of the front end chip of the transceiver device to the database containing the locations of the incumbent devices; obtaining, from the database, reapproval for the transceiver device to operate in the high power mode, based on the location information indicating (updated) locations of the (active) incumbent devices; and continuing to operate the transceiver device in the high power mode, responsive to obtaining the reapproval.

In one or more embodiments, in the step of storing the geographic location information in the memory portion of the tag device, the geographic location information comprises longitude “X” information, latitude “Y” information and, elevation “Z” information (can be altitude above ground or above sea level). Additional information can include a router identification (e.g., MAC of transceiver and/or router serial number), and optionally, a location measurement technique.

In one or more embodiments, reading the location information with the reader portion of the front end chip of the transceiver device adjacent the tag device comprises the reader portion of the front end chip of the transceiver device wirelessly interrogating the tag device via near field communications.

One or more instances further include advising at least one of a technician or a consumer using at least one of a web site, a mobile device with a technician application, or a customer device with a customer application. As used herein, “At least one of an A and a B means” one or more A AND/OR one or more B.

One or more embodiments further include, after a predetermined time, attempting to repeat reading the location information with the reader portion of the front end chip of the transceiver; and, responsive to failure of the attempting to repeat the reading of the location information with the reader portion of the front end chip of the transceiver, operating the transceiver device in the low power mode.

In another aspect, a kit of parts includes a tag device having a memory portion configured to store geographic location information and an adhesive portion configured to be affixed to a fixed surface; and a transceiver device having a high power mode and a low power mode, a network interface configured to communicate over a network with a database containing locations of incumbent devices, and a front end chip with a reader portion configured to read the location information. Optionally, the kit could include instructions for how to set up the tag device and transceiver device, as described herein; for example, in printed English or another printed language, a two-dimensional barcode to read, and so on.

In another aspect, an exemplary method includes retrieving a service address (i.e., a street address including a street, number, city, state, and zip code, or equivalent in a non-US jurisdiction) from a database of an internet service provider, such as billing module 152. A further step incudes obtaining a corresponding geographic location (e.g., latitude and longitude pair) from a geographic information system server 1806 based on the service address. GIS server 1806 can be in an ISP premises, a third party premises (e.g., GIS provider), instantiated as a web service in the cloud, or the like. Still a further step includes associating a transceiver device 1801 with the geographic location. In one or more embodiments, the transceiver device is configurable to operate in a standard power mode and a low power mode having a lower power than the standard power mode. In one or more embodiments, as described elsewhere, it is known that the router is within a certain radius as shown in FIG. 19 (an ellipse degenerates to circle if the home is approximately square), the circle bounds the four corners of the house and the transceiver is known to be an indoor device (router is typically attached to the cable modem or the like). It is known that the router is somewhere in the 39.5 foot radius circle with required confidence (e.g., >95% confidence).

Yet a further step includes making the geographic location available, over a network (e.g., the Internet), to a database 1809 containing locations of active incumbent devices (e.g., in database portion 1815). An additional step includes obtaining, from the database 1809, approval for the transceiver device 1801 to operate in the standard power mode, based on the geographic location and the locations of the incumbent devices. Note that the calculation engine 1817 is a “known black box,” typically a cloud server or the like, which performs calculations specified by a cognizant regulatory authority. Another additional step includes operating the transceiver device 1801 in the standard power mode, responsive to obtaining the approval.

In one or more embodiments, the geographic location data includes latitude and longitude, and a further step includes making altitude-related data from the transceiver device 1801 available, over the network, to the database 1809 containing locations of active incumbent devices (e.g., in portion 1815). The approval for the transceiver device to operate in the standard power mode is further based on the altitude-related data. The altitude-related data can include Z determined as described elsewhere herein (MEMS barometer, e.g.).

One or more embodiments further include repeating, for a plurality of additional transceiver devices 1801 (also configurable to operate in the standard power mode and the low power mode), the steps of retrieving of the service address, obtaining of the corresponding geographic location, associating each transceiver device of the plurality with the geographic location, making the geographic location and the altitude-related data available, obtaining approval for the transceiver device to operate in the standard power mode, and the operating of the transceiver device in the standard power mode, responsive to obtaining the approvals.

As noted, devices 1801 could communicate directly with database 1809 but in many instances will utilize the (intermediate) domain proxy server 1803. Thus, one or more embodiments further include aggregating the geographic location and the altitude-related data at a domain proxy server 1803 of the internet service provider; the geographic location and the altitude-related data are made available to the database 1809 from the domain proxy server.

As described elsewhere herein, in one or more embodiments, associating the transceiver device with the geographic location includes checking the transceiver device 1801 with a corresponding node. The corresponding node could be, for example, a local service node 182 in FIG. 4, while the device 1801 could be CPE 106, associated with CPE 106, or part of CPE 106. In a fiber embodiment, the node could be, for example, a secondary distribution cabinet 816, and the device 1801 could be S-ONU 822-1, 822-2, . . . 822-64, associated with the S-ONU 106, or part of the S-ONU.

Furthermore regarding GIS server 1806, in one or more embodiments, the customer's service (street) address is derived from the billing system—e.g., billing module 152. It is known where the corresponding modem is installed. It can be seen that the IP address associated with that modem lies within a certain CMTS node 182 or the equivalent in a fiber network. A cross-check can be made that the service address resides within the CMTS node. After that is confirmed, the service address goes into GIS server 1806. This aspect can be thought of as a lookup table which converts service (street) address into data usable by a GPS, say, X and Y coordinates out to 6 or 7 decimal places. Given the teachings herein, the skilled person can implement the cross-check versus the service node by carrying out database queries to the billing system (e.g., billing module 152) of an ISP. In one or more embodiments, the GIS server 1806 includes location data for all of the CMTS nodes 182, which are typically the very endpoints before service goes to the premises—say, feeding a block or cul-de-sac. If a dot 1702 is found within the region associated with the corresponding CMTS node, there will be high confidence that the service address from the database is good. In FIG. 17, “zoom in”—provide the service address to the GIS server 1806 and look at the level of granularity of a house 1706.

In one or more embodiments, associating the transceiver device with the geographic location includes: identifying a first group of service locations from the internet service provider database that fall within building outlines from the geographic information system (solid dots 1702); and discarding a second group of service locations from the internet service provider database that fall outside of building outlines from the geographic information system (open dots 1704). In this aspect, the transceiver device is associated with the first group of service locations. Note that the “node check” can be, but need not necessarily be, done prior to this aspect.

Referring, for example, to FIG. 20, in one or more embodiments, making the geographic location available includes specifying at least one of an ellipse, a linear polygon (linearPolygon), and a radial polygon (radialPolygon). Refer, for example, to Signaling Protocols and Procedures for 6 GHz Band, AFC System—Standard Power Device Interface Technical Specification Document WINNF-TS-3007 Version V1.0.0 1 Sep. 2022, expressly incorporated by reference herein, in its entirety, for all purposes.

One or more embodiments further include repeating the step of making the geographic location available after a predetermined time period (e.g., 24 hours, or whatever other period is specified by a cognizant regulatory authority); then, responsive to the repeated step, obtaining, from the database 1809, updated approval for the transceiver device 1801 to continue to operate in the standard power mode, based on the geographic location and updated locations of the incumbent devices; and continuing to operate the transceiver device in the standard power mode, responsive to obtaining the approval. Of course, it is possible that circumstances could change as described elsewhere herein, and re-approval might not be granted. Thus, one or more embodiments further include repeating the step of making the geographic location available after the predetermined time period; and then, responsive to the repeated step, obtaining, from the database 1815, denial for the transceiver device to continue to operate in the standard power mode, based on the geographic location and updated locations of the incumbent devices; and operating the transceiver device in the low power mode, responsive to obtaining the denial.

It should be noted that in addition to repeating certain delineated steps for multiple devices 1801 and repeating certain steps every predetermined time period (e.g., 24 hours), the steps can be repeated for the multiple devices every predetermined time period.

In another aspect, an exemplary system includes a memory, and at least one processor, coupled to the memory, and operative to carry out or otherwise facilitate any one, some, or all of the method steps disclosed herein. For example, in one or more embodiments, the at least one processor is operative to retrieve a service address from a database of an internet service provider; obtain a corresponding geographic location from a geographic information system server based on the service address; associate a transceiver device with the geographic location, the transceiver device being configurable to operate in a standard power mode and a low power mode having a lower power than the standard power mode; make the geographic location available, over a network, to a database containing locations of active incumbent devices; obtain, from the database, approval for the transceiver device to operate in the standard power mode, based on the geographic location and the locations of the active incumbent devices; and cause operation of the transceiver device in the standard power mode, responsive to obtaining the approval.

For example, the system could be implemented on the domain proxy server 1801, optionally with one or more other servers in communication therewith. The system can optionally include the devices 1801. The system can optionally include an interface to the GIS server 1806, or even the GIS server 1806 itself. The system can optionally include the billing module 152. The components can be coupled using techniques that will be apparent to the skilled artisan given the teachings herein, including an HFC network, optical network, Internet connection using TCP/IP, and the like.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

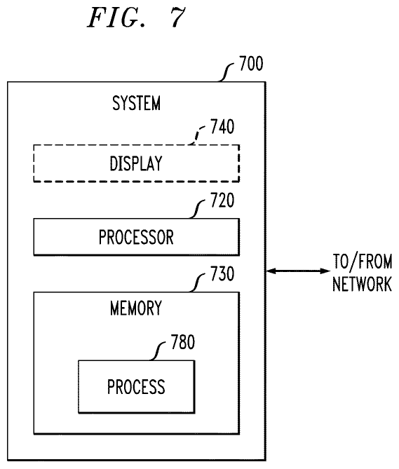

FIG. 7 is a block diagram of at least a portion of an exemplary system 700 that can be configured to implement at least some aspects of the invention, and is representative, for example, of one or more of the apparatus or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
storing geographic location information in a memory portion of a tag device;
affixing the tag device on a fixed surface;
reading the location information with a reader portion of a front end chip of a transceiver device adjacent the tag device, the transceiver device having a high power mode and a low power mode;
making the location information available, over a network, from the reader portion of the front end chip of the transceiver device to a database containing locations of active incumbent devices;
obtaining, from the database, approval for the transceiver device to operate in the high power mode, based on the location information and the locations of the active incumbent devices; and
operating the transceiver device in the high power mode, responsive to obtaining the approval.

2. The method of claim 1, further comprising:
after a predetermined time, repeating reading the location information with the reader portion of the front end chip of the transceiver device and making the location information available, over the network, from the reader portion of the front end chip of the transceiver device to the database containing the locations of the incumbent devices;
obtaining, from the database, disapproval for the transceiver device to operate in the high power mode, based on the repeated location information and updated locations of the active incumbent devices; and
operating the transceiver device in the low power mode, responsive to obtaining the disapproval.

3. The method of claim 2, further comprising designating the stored geographic location information in the memory portion of the tag device as read only.

4. The method of claim 3, wherein storing the geographic location information in the memory portion of the tag device comprises storing by a technician using a mobile device with a technician application.

5. The method of claim 3, wherein storing the geographic location information in the memory portion of the tag device comprises storing by a customer using a customer device with a customer application.

6. The method of claim 1, further comprising:
after a predetermined time, repeating reading the location information with the reader portion of the transceiver and making the location information available, over the network, from the reader portion of the front end chip of the transceiver device to the database;
obtaining, from the database, reapproval for the transceiver device to operate in the high power mode, based on the location information and updated locations of the active incumbent devices; and
continuing to operate the transceiver device in the high power mode, responsive to obtaining the reapproval.

7. The method of claim 1, wherein, in the step of storing the geographic location information in the memory portion of the tag device, the geographic location information comprises longitude information, latitude information, elevation information, and a router identification.

8. The method of claim 1, wherein reading the location information with the reader portion of the front end chip of the transceiver device adjacent the tag device comprises the reader portion of the front end chip of the transceiver device wirelessly interrogating the tag device via near field communications.

9. The method of claim 1, further comprising advising at least one of a technician or a consumer using at least one of a web site, a mobile device with a technician application; or a customer device with a customer application.

10. The method of claim 1, further comprising:
after a predetermined time, attempting to repeat reading the location information with the reader portion of the front end chip of the transceiver device; and
responsive to failure of the attempting to repeat the reading of the location information with the reader portion of the front end chip of the transceiver device, operating the transceiver device in the low power mode.

11. A kit of parts comprising:
a tag device having a memory portion configured to store geographic location information and an adhesive portion configured to be affixed to a fixed surface; and
a transceiver device having a high power mode and a low power mode, a network interface configured to communicate over a network with a database containing locations of incumbent devices, and a front end chip with a reader portion configured to read the location information.

12. A method comprising:
retrieving a service address from a database of an internet service provider;
obtaining a corresponding geographic location from a geographic information system server based on the service address;
associating a transceiver device with the geographic location, the transceiver device being configurable to operate in a standard power mode and a low power mode having a lower power than the standard power mode;
making the geographic location available, over a network, to a database containing locations of active incumbent devices;
obtaining, from the database, approval for the transceiver device to operate in the standard power mode, based on the geographic location and the locations of the active incumbent devices; and
operating the transceiver device in the standard power mode, responsive to obtaining the approval.

13. The method of claim 12, where the geographic location data includes latitude and longitude, further comprising making altitude-related data from the transceiver device available, over the network, to the database containing locations of active incumbent devices, wherein the approval for the transceiver device to operate in the standard power mode is further based on the altitude-related data.

14. The method of claim 13, further comprising repeating, for a plurality of additional transceiver devices configurable to operate in the standard power mode and the low power mode, the retrieving of the service address, obtaining of the corresponding geographic location, associating each transceiver device of the plurality of additional transceiver devices with a corresponding geographic location, making the corresponding geographic location and corresponding altitude-related data available, obtaining approval for each transceiver device of the plurality of additional transceiver devices to operate in the standard power mode, and the operating of each transceiver device of the plurality of additional transceiver devices in the standard power mode, responsive to obtaining the approvals.

15. The method of claim 14, further comprising aggregating the geographic location and the altitude-related data at a domain proxy server of the internet service provider, wherein the geographic location and the altitude-related data are made available to the database from the domain proxy server.

16. The method of claim 15, further comprising:
repeating the step of making the geographic location available after a predetermined time period, and, responsive to the repeated step, obtaining, from the database, updated approval for the transceiver device to continue to operate in the standard power mode, based on the geographic location and updated locations of the incumbent devices; and
continuing to operate the transceiver device in the standard power mode, responsive to obtaining the approval.

17. The method of claim 15, further comprising:
repeating the step of making the geographic location available after a predetermined time period, and, responsive to the repeated step, obtaining, from the database, denial for the transceiver device to continue to operate in the standard power mode, based on the geographic location and updated locations of the incumbent devices; and
operating the transceiver device in the low power mode, responsive to obtaining the denial.

18. The method of claim 12, wherein associating the transceiver device with the geographic location includes checking the transceiver device with a corresponding node.

19. The method of claim 12, wherein associating the transceiver device with the geographic location includes:
identifying a first group of service locations from the internet service provider database that fall within building outlines from the geographic information system; and
discarding a second group of service locations from the internet service provider database that fall outside of building outlines from the geographic information system;
wherein the transceiver device is associated with the first group of service locations.

20. The method of claim 12, wherein making the geographic location available includes specifying at least one of an ellipse, a linear polygon, and a radial polygon.

21. A system comprising:
a memory; and
at least one processor, coupled to the memory, and operative to:
retrieve a service address from a database of an internet service provider;
obtain a corresponding geographic location from a geographic information system server based on the service address;
associate a transceiver device with the geographic location, the transceiver device being configurable to operate in a standard power mode and a low power mode having a lower power than the standard power mode;
make the geographic location available, over a network, to a database containing locations of active incumbent devices;
obtain, from the database, approval for the transceiver device to operate in the standard power mode, based on the geographic location and the locations of the active incumbent devices; and
cause operation of the transceiver device in the standard power mode, responsive to obtaining the approval.
